(19) United States
(12) Patent Application Publication
(10) Pub. No.: US 2026/0142163 A1
(43) Pub. Date: May 21, 2026

(54) CATHODE ACTIVE MATERIAL COATED WITH FLUORINE-DOPED LITHIUM PHOSPHORUS OXIDE AND SULFIDE ALL-SOLID-STATE BATTERY COMPRISING SAME

(71) Applicant: Factorial Inc., Billerica, MA (US)

(72) Inventors: Minh Nguyen, Lowell, MA (US); Fang Hao, Andover, MA (US); Joanna Burdynska, Woburn, MA (US); Benjamin Abraham, Tallahassee, FL (US); Hyun Seok Kim, Lexington, MA (US)

(21) Appl. No.: 19/484,903

(22) PCT Filed: Jul. 10, 2025
(86) PCT No.: PCT/US2025/037083

§ 371 Date: Nov. 17, 2025

Related U.S. Application Data
(60) Provisional application No. 63/670,225, filed on Jul. 12, 2024.

(51) Int. Cl. H01M 4/36; C01G 53/42; H01M 4/02; H01M 4/525; H01M 4/58; H01M 10/0525

(52) U.S. Cl. CPC H01M 4/366; C01G 53/42; H01M 4/525; H01M 4/5825; C01P 2002/54; C01P 2004/80; C01P 2006/40; H01M 2004/021; H01M 10/0525

(57) ABSTRACT

Disclosed is a cathode active material (CAM) particle at least partially coated with a fluorine-doped lithium phosphorus oxide (LPOF), wherein the fluorine-doped lithium phosphorus oxide has a formula (I), (Li₂O)ₓ—(P₂O₅)_{y}—(AFₘ)_{z}, wherein A is an alkali metal or alkaline earth metal, m is 1 or 2, x+y+z=1.0, 0.3<x<0.8, 0.2<y<0.7, and 0<z<0.2. Also disclosed is a cathode layer comprising the coated CAM and an all-solid-state battery comprising the cathode layer. In some embodiments, the battery comprising a cathode with the LPOF-coated CAM exhibits an improved rate performance and cycling performance.

### CROSS-REFERENCE

The present application claims the benefit of U.S. Ser. No. 63/670,225, filed Jul. 12, 2024, the entire content of which is incorporated herein by reference into this application.

### FIELD

The present disclosure relates to cathode active materials coated with fluorine-doped lithium phosphorus oxide (LPOF) and a sulfide-based all-solid-state battery (ASSB) comprising the same.

### BACKGROUND

All-solid-state batteries (ASSBs) are considered as promising candidates for future energy storage devices as lithium metal is being explored as anode active material due to its higher specific energies compared to conventional lithium-ion batteries based on organic liquid electrolytes.

Sulfide solid electrolyte (SE) materials comprise S⁻² and have narrow intrinsic electrochemical windows. Thiophosphate-based solid electrolytes (SEs) contain elements phosphorus (P) and sulfur (S) and are particularly promising because of their high ionic conductivities, good mechanical compatibility, and relatively low costs. Passivation of SEs, however, is necessary for the reversible operation of ASSBs. Conventional high-capacity cathode active materials (CAMs) may be a lithium metal oxide such as LiNi_{0.88}Co_{0.09}Al_{0.03}O₂(NCA88). Adaption of the conventional CAMs to ASSBs usually leads to less desirable interfacial resistances. There are two ways to improve the compatibility with high-voltage cathodes. First, SEs with high-anodic limit and good interfacial stability may be used. Second, protective coatings or layers can be applied on cathodes. In an ASSB with sulfide-based electrolytes, the S/O exchange at the CAM/SE interface and the poor ion-conducting properties of the resulting degradation compositions are of major concerns. Lithium metal fluoride (LMF) type CAM coatings may offer improved electrochemical stability due to the electronegativity of fluorine and reduced O/F and S/F atom exchange between the CAM/coating and SE/coating. However, LMF type coatings generally have lower Li ion conductivities compared to their oxide counterparts, which limits high-rate capabilities in the cell. Thus, CAMs with new coatings are needed.

### SUMMARY

Disclosed herein is a CAM at least partially coated with a fluorine-doped lithium phosphorus oxide (LPOF), wherein the LPOF has a formula of (Li₂O)ₓ—(P₂O₅)_{y}—(AFₘ)_{z}, x+y+z=1.0, 0.3<x<0.8, 0.2<y<0.7, and 0<z<0.4, A is an alkali metal or alkaline earth metal, and wherein m is 1 or 2. Also disclosed is a cathode layer comprising the coated CAM and an all-solid-state battery comprising the cathode layer.

### BRIEF DESCRIPTION OF THE FIGURES

Non-limiting embodiments of the present disclosure will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the disclosure shown where illustration is not necessary to allow those of ordinary skill in the art to understand the disclosure.

FIG. 1 shows a representative structure of a cathode layer comprising a coated CAM particle according to one embodiment of the present disclosure.

FIG. 2 shows a typical structure of an all-solid-state battery (ASSB) according to one embodiment of the present disclosure.

FIG. 3 shows a ternary phase diagram for CAM coatings according to some embodiments of the present disclosure.

FIG. 4A shows the discharge capacity retention (%) of cells with a cathode of comparative examples during the rate test.

FIG. 4B shows the discharge capacity retention (%) of cells with a cathode of comparative examples during the cycling test.

FIG. 5A shows the discharge capacity retention (%) of cells with a cathode of examples during the rate test according to some embodiments of the present disclosure.

FIG. 5B shows the discharge capacity retention (%) of cells with a cathode of examples during the cycling test according to some embodiments of the present disclosure.

FIG. 6 shows the discharge capacity retention (%) of cells with a cathode of example 3 with different thicknesses during the rate test and cycling test according to some embodiments of the present disclosure.

FIG. 7 shows the discharge capacity retention (%) of cells with a cathode of example 4 with different thicknesses during the rate test and cycling test according to some embodiments of the present disclosure.

FIG. 8 shows the discharge capacity retention (%) of cells with a cathode of example 5 with different thicknesses during the rate test and cycling test according to some embodiments of the present disclosure.

### DETAILED DESCRIPTION

The present disclosure provides a CAM at least partially coated with a fluorine-doped lithium phosphorus oxide (LPOF), wherein the fluorine-doped lithium phosphorus oxide has a formula (I), (Li₂O)ₓ—(P₂O₅)_{y}—(AFₘ)_{z} (formula I), x+y+z=1.0, 0.3<x<0.8, 0.2<y<0.7, and 0<z<0.4, and A is an alkali metal or alkaline earth metal, wherein m is 1 or 2. Also disclosed is a cathode layer comprising the coated CAM and an all-solid-state battery comprising the cathode layer.

In some embodiments, A comprises at least one selected from the group consisting of Li, Na, K, Mg, Ca and combinations thereof.

Without wishing to be bound by any theory, such a coating can minimize the degradation of a sulfide solid electrolyte (SE) at the interface between the SE and the coated CAM when the coated CAM is incorporated into a cathode layer of an ASSB. In some embodiments, the reduced degradation of the SE improves the overall cycling stability and discharge capacity. In some embodiments, the LPOF coating improves kinetic performance with higher capacity retentions at high charge/discharge rates such as 1C, 2C, and 5C.

In some embodiments, the cathode active material (CAM) is particulate in form in that it is made of a plurality of individual CAM particles. In some embodiments, each particle of the CAM particulate is at least partially coated with a fluorine-doped lithium phosphorus oxide (LPOF) with a formula of (Li₂O)ₓ—(P₂O₅)_{y}—(AFₘ)_{z} (formula I), wherein x+y+z=1.0, 0.3<x<0.8, 0.2<y<0.7, and 0<z<0.4.

In some embodiments, the coated CAM, for example, a coated CAM particulate, is incorporated into a cathode layer as shown for example in FIG. 1. A cathode comprises individual particles of a cathode active material (CAM) (1) with LPOF as a CAM coating (2), electrically conducting material, such as carbon fibers (4), and a solid electrolyte, such as a sulfur-containing inorganic electrolyte or sulfide based solid electrolyte (3).

In some embodiments, the molar ratio of AFₘ to P₂O₅ in formula (I) is higher than zero. In some embodiments, the molar ratio of AFₘ to P₂O₅ is no greater than 0.30 or no greater than 0.25. In some embodiments, AFₘ comprises at least one selected from the group consisting of LiF, NaF, MgF₂, and CaF₂.

In some embodiments, the molar ratio of fluorine (F) to phosphorus (P) in formula (I) is higher than zero. In some embodiments, the molar ratio of F to P is no greater than 0.15, no greater than 0.14, no greater than 0.13, no greater than 0.12 or no greater than 0.11.

In some embodiments, the formula has an F/(Li+P+O) ratio greater than zero and no greater than 0.025, wherein the F/(Li+P+O) ratio is a molar ratio of fluorine (F) to lithium (Li), phosphorous (P) and oxygen (O). In some embodiments, the F/(Li+P+O) ratio is greater than zero and no greater than 0.022.

In some embodiments, as shown in FIG. 1, a cathode layer comprises a CAM particle (1) with surface at least partially coated with a coating of LPOF (2), an electronically conductive carbon fiber (4), and a sulfide SE (3).

In some embodiments, cathode active materials include without limitation: LiₓMn_{1-y}M_{y}A₂(Formula 1), LiₓMn_{1-y}M_{y}O_{2-z}X_{z} (Formula 2), LiₓMn₂O₄-X_{z} (Formula 3), LiₓMn_{2-y}M_{y}A₄ (Formula 4), LiₓCo_{1-y}M_{y}A₂ (Formula 5), LiₓCo_{1-y}M_{y}O_{2-z}X_{z} (Formula 6), LiₓNi_{1-y}M_{y}A₂ (Formula 7), LiₓNi_{1-y}M_{y}O_{2-z}X_{z} (Formula 8), LiₓNi_{1-y}Co_{y}O_{2-z}X_{z}(Formula 9), LiₓNi_{1-y-z}Co_{y}M_{z}Aₐ, (formula 10), LiₓNi_{1-y-z}Co_{y}M_{z}O₂₋ₐXₐ (Formula 11), LiₓNi_{1-y-z}Mn_{y}M_{z}Aₐ (Formula 12), LiₓNi_{1-y-z}Mn_{y}M_{z}O₂₋ₐXₐ (Formula 13), LiₓNi_{1-y-z}Mn_{y}M_{z}O₂ (Formula 14) and combinations thereof wherein 0.95≤x≤1.1, 0≤y≤0.5, 0≤z≤0.5, 0≤a≤2; M is selected from the group consisting of Al, Ni, Co, Mn, Cr, Fe, Mg, Sr, V, and rare earth elements; A is selected from the group consisting of O, F, S, and P; and X is selected from the group consisting of F, S, and P.

In some embodiments, the CAM is a particulate in the form of a plurality of induvial particles, wherein the particles have an median particle size in a range from about 1 μm to about 15 μm, about 1 μm to about 12 μm, about 1 μm to about 10 μm, about 1 μm to about 7 μm, about 1 μm to about 6 μm, about 3 μm to about 15 μm, about 3 μm to about 12 μm, about 3 μm to about 10 μm, about 3 μm to about 7 μm, about 3 μm to about 6 μm, about 5 μm to about 15 μm, about 5 μm to about 12 μm, about 5 μm to about 10 μm and all ranges and subranges therebetween. In some embodiments, the coated CAM may have a weight percentage in a range from about 50 wt % to about 99 wt %, about 50 wt % to about 95 wt %, about 50 wt % to about 90 wt %, about 50 wt % to about 85 wt %, about 50 wt % to about 80 wt %, about 55 wt % to about 99 wt %, about 55 wt % to about 95 wt %, about 55 wt % to about 90 wt %, about 55 wt % to about 85 wt %, about 55 wt % to about 80 wt %, about 60 wt % to about 99 wt %, about 60 wt % to about 95 wt %, about 60 wt % to about 90 wt %, about 60 wt % to about 85 wt %, about 60 wt % to about 80 wt %, about 65 wt % to about 99 wt %, about 65 wt % to about 95 wt %, about 65 wt % to about 90 wt %, about 65 wt % to about 85 wt %, about 65 wt % to about 80 wt %, about 70 wt % to about 99 wt %, about 70 wt % to about 95 wt %, about 70 wt % to about 90 wt %, about 70 wt % to about 85 wt %, about 70 wt % to about 80 wt %, and all range and subranges therebetween in the cathode layer. In some embodiments, the CAM particles may be polycrystalline or single crystalline. In some embodiments, the CAM particles may have a single particle size distribution or multiple particle size distributions.

In some embodiments, the LPOF coating on CAM particle may have an average thickness in a range from 0.5 nm to 10.0 nm, from 0.8 nm to 10.0 nm, from 1.0 nm to 10.0 nm, from 2.0 to 10.0 nm, from 0.5 nm to 8.0 nm, from 0.8 nm to 8.0 nm, from 1.0 nm to 8.0 nm, from 2.0 to 8.0 nm, from 0.5 nm to 5.0 nm, from 0.8 nm to 5.0 nm, from 1.0 nm to 5.0 nm, from 2.0 to 5.0 nm, or any and all subranges and ranges therebetween. In some embodiments, the thickness is measured by observing the cross section of a dissected particle using a scanning electron microscope (SEM). In some embodiments, the thickness is measured on a transmission electron microscope (TEM).

In some embodiments, the average thickness of the LPOF coating on the surface of the CAM particle is critical. In some embodiments, the average thickness of the LPOF coating is no greater than 5.0 nm. In some embodiments, the average thickness of the LPOF coating is no greater than 3.0 nm. In some embodiments, the average thickness of the LPOF coating is no less than 0.5 nm. In some embodiments, the average thickness of the LPOF coating is no less than 1.0 nm.

In some embodiments, the CAM particle coated with the LPOF exhibits a core-shell structure. The core is a CAM particle while the shell is the LPOF coating surrounding the CAM particle.

In some embodiments, the electrically conductive material is a carbonaceous material in zero dimension or one dimension such as carbon particles, carbon nanotubes and carbon fiber. In some embodiments, the electrically conductive material includes without limitation vapor grown carbon fiber (VGCF), carbon nanotube (CNT), multi-walled carbon nanotubes (MWCNT), carbon nanofiber, and graphite fiber. In some embodiments, the electrically conductive material may have a BET measured specific surface area in a range from 1 to 600 m²/g and/or an electrical resistance of no more than 0.5 Ω·cm. In some embodiments, the electrically conductive material may be coated with an oxide material. In some embodiments, the electrically conductive material, either coated or uncoated, has a weight percentage in a range from 0.01 wt % to 5 wt %, 0.01 wt % to 4 wt %, 0.01 wt % to 3 wt %, 0.01 wt % to 2 wt %, 0.5 wt % to 5 wt %, 0.5 wt % to 4 wt %, 0.5 wt % to 3 wt %, 0.5 wt % to 2 wt %, 1 wt % to 5 wt %, 1 wt % to 4 wt %, 1 wt % to 3 wt %, 2 wt % to 5 wt %, 2 wt % to 4 wt %, and any or all ranges and subranges therebetween in the cathode layer.

In some embodiments, a method for preparing the coated cathode active materials is disclosed. A coating solution including a solvent, a lithium precursor, a fluoride precursor, and a phosphorus oxide precursor can be prepared, wherein the amounts of the lithium, fluoride, and phosphorus oxide precursors are calculated based on the formula of (Li₂O)ₓ—(P₂O₅)_{y}—(AFₘ)_{z} (formula I), wherein x+y+z=1.0, 0.3<x<0.8, 0.2<y<0.7, and 0<z<0.4. In some embodiments, the solvent for preparing the coating solution is non-aqueous and comprises one or more selected from the group consisting of methanol, ethanol, isopropanol, n-propanol, t-butanol, tetrahydrofuran, and mixtures thereof. The coating solution can be applied to the particles of uncoated cathode active material followed by an annealing, whereby the lithium, fluoride and phosphorus oxide precursors are converted to a LPOF coating on the particle surface. In some embodiments, the annealing is conducted at a temperature in a range from 150° C. to 500° C. for a duration in a range from 0.5 to 3 hours under an oxygen atmosphere. In addition or alternatively, a coating solution may be applied to the uncoated cathode active material by spray coating. In other embodiments, the coating solution can be applied by mixing the uncoated cathode active material with the coating solution to form a mixture. After the solvent can is removed from the mixture, a gel containing the lithium precursor, the fluoride precursor and the phosphorus oxide precursor is formed on the surface of the particle. The method is referred to herein as a sol-gel method.

In some embodiments, the solid electrolyte may be any sulfide solid electrolyte as long as it contains Li and S and possesses a desired lithium-ion conductivity. The sulfide solid electrolyte may be any crystalline material, glass ceramic, and glass. In some embodiments, the solid electrolyte is a lithium-phosphorus-sulfur (LPS) electrolyte. Examples of the sulfide solid electrolyte include Li₂S—P₂S₅, Li₂S—P₂S₅-LiHa (“Ha” is one or more halogen elements), Li₂S—P₂S₅—P₂O₅, Li₂S—Li₃PO₄—P₂S₅, Li₃PS₄, Li₄P₂S₆, Li₁₀GeP₂S₁₂, Li_{3.25}Ge_{0.25}P_{0.75}S₄, Li₇P₃S₁₁, Li_{3.25}P_{0.95}S₄, and Li₇₋ₓPS₆₋ₓHaₓ (argyrodite-type solid electrolyte, “Ha” is one or more halogen elements, where 0.2<x<1.8). In some embodiments, sulfide solid electrolyte may have a weight percentage of in a range from 1 wt % to 35 wt %, 1 wt % to 30 wt %, 1 wt % to 25 wt %, 1 wt % to 20 wt %, 1 wt % to 15 wt %, 1 wt % to 10 wt %, 5 wt % to 35 wt %, 5 wt % to 30 wt %, 5 wt % to 25 wt %, 5 wt % to 20 wt %, 5 wt % to 15 wt %, 10 wt % to 35 wt %, 10 wt % to 30 wt %, 10 wt % to 25 wt %, 10 wt % to 20 wt %, 15 wt % to 35 wt %, 15 wt % to 30 wt %, 15 wt % to 25 wt %, 20 wt % to 30 wt % and any and all ranges and subranges therebetween in the cathode layer.

In some embodiments, the coated CAM particulate is mixed with other components such as electrically conductive material, binder and/or solid electrolyte, ground, and pressed to form a cathode layer. In some embodiments, a cathode layer is sandwiched between a cathode current collector and a solid electrolyte layer. In some embodiments, the cathode layer includes a cathode active material (CAM) that requires both lithium ion (Li+) and electron (e−) connectivity with the solid electrolyte layer and current collector, respectively. The Li+ connectivity is mainly provided by small particles of sulfide-based solid electrolyte in the cathode layer, and the e− connectivity is mainly provided by the electrically conductive material. The sulfide-based solid electrolytes (such as the exemplary sulfide solid electrolyte set forth above) have a high Li+ conductivity. However, they generally degrade at potentials below 1.7 V or above 2.1 V vs. Li/Li+ at the CAM/SE, CF/SE, and current collector/SE interface. The degraded byproducts generally have a lower Li+ conductivity, which in return requires a higher percentage of SE in the cathode composite layer, leading to a lower percentage of CAM. Without wishing to be bound by theory, the LPOF coating disclosed herein prolongs the time for degradation, maintains a relatively higher Li+ conductivity, and thus improves the overall battery cell performance.

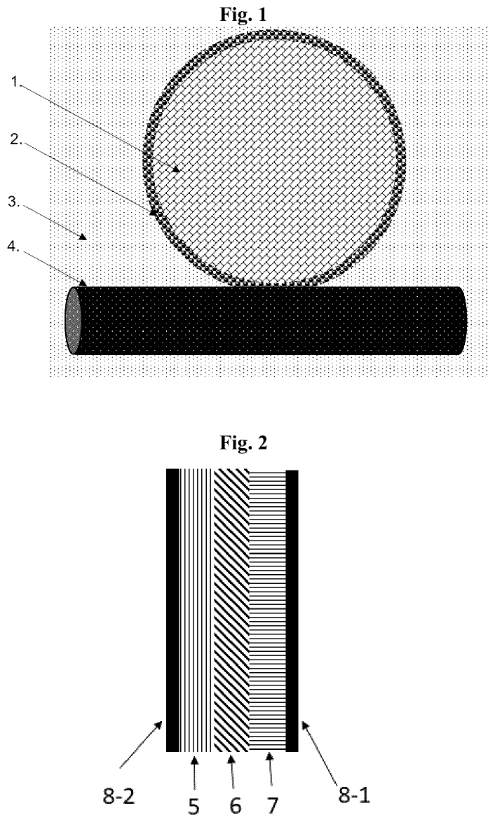

The cathode layer disclosed above can be incorporated into an all-solid-state battery. As shown for example in FIG. 2, an all-solid-state battery comprises a cathode layer (5), a cathode current collector (8-2), an anode layer (7), an anode current collector (8-1), and a solid electrolyte layer (6) sandwiched between the anode layer (7) and the cathode layer (5). In some embodiments, the solid electrolyte material in the solid electrolyte layer is the same as the solid electrolyte material in the cathode layer. In some embodiments, the solid electrolyte material in the solid electrolyte layer is different from the solid electrolyte material in the cathode layer.

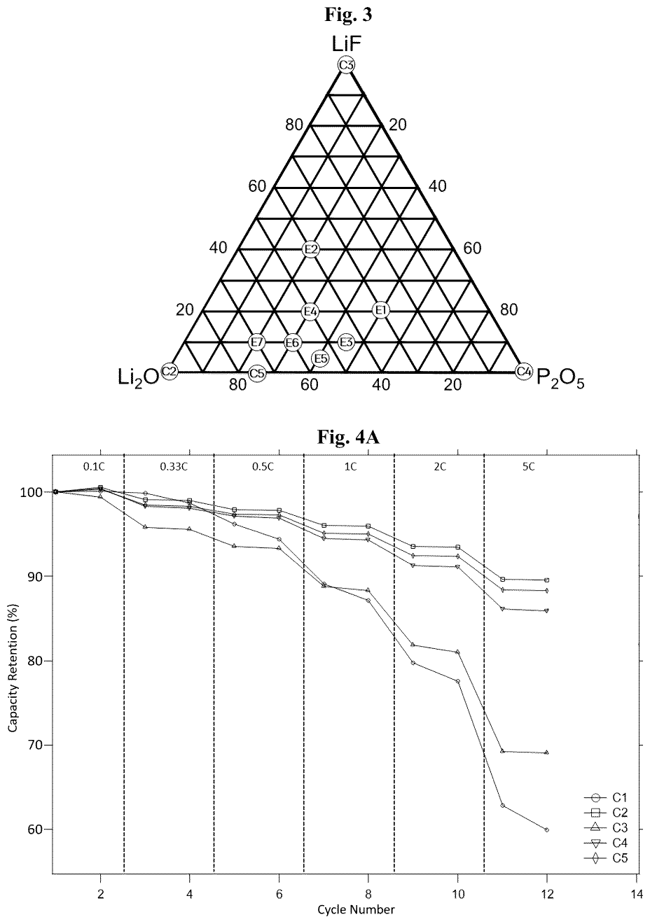

FIG. 3 shows a ternary phase diagram for CAM coatings according to some embodiments of the present disclosure, wherein each corner corresponds to a pure component with the bottom, left, and right axis corresponding to the molar fraction of Li₂O, LiF, and P₂O₅, respectively.

In some embodiments, the solid electrolyte layer is an inorganic solid electrolyte layer, for example a sulfur-containing inorganic electrolyte.

In some embodiments, the sulfur-containing inorganic electrolyte has a formula LiₓM1_{y}M2_{z}P₁₋ₚM3ₚS_{6-a-b-q}O_{q}ClₐBr_{b} (Formula II), 4≤x≤8, 0≤y≤1, 0≤z<1, 0≤p<1, 0≤q<1, 0≤a≤2, 0≤b<2, 0<6-a-b-q<6, 0<1-p≤1, wherein M1 is at least one element of Group 1 or Group 11 other than H or Li of the periodic table, M2 is at least one element of Group 2 of the periodic table, and M3 is at least one element of Group 14 of the periodic table. In some embodiments, M1 is at least one selected from the group consisting of Na, K, Rb, Cs, Cu, Ag and Au. In some embodiments, M2 is at least one selected from the group consisting of Be, Mg, Ca, Sr and Ba. In some embodiments, M3 is at least one selected from the group consisting of Si, Ge, Sn and Pb.

In some embodiments, the ASSB has an initial discharge specific capacity of at least 215.0 mAh/g, at least 216.0 mAh/g, at least 217.0 mAh/g, at least 218.0 mAh/g, at least 219.0 mAh/g or at least 220.0 mAh/g at a charge/discharge rate of 0.1C at 75° C.

In some embodiments, the ASSB can be tested at an external pressure in a range from 0.5 MPa to 5.0 MPa.

In some embodiments, the ASSB has a discharge capacity retention of at least 92.50%, at least 92.60%, at least 92.70%, at least 92.75%, at least 92.80%, 92.85%, or at least 92.90% at a discharge rate of 2C at 75° C., wherein the capacity retention is the 1^{st} specific discharge capacity divided by the initial specific discharge capacity at 0.1C multiplied by 100%.

In some embodiments, the ASSB has a discharge capacity retention of at least 88.50%, at least 88.60%, at least 88.70%, at least 88.75%, at least 88.80%, 88.85%, at least 88.90%, or at least 89.00% at a discharge rate of 5C at 75° C., wherein the capacity retention is the 1^{st} specific discharge capacity at a discharge rate of 5C at 75° C. divided by the initial specific discharge capacity at 0.1C at 75° C. multiplied by 100%.

In some embodiments, the ASSB exhibits a first 20 cycles stability of at least 99.20%, at least 99.30%, at least 99.40%, at least 99.45%, at least 99.50%, at least 99.55%, or at least 99.60%. The first 20 cycles stability is the ratio of the discharge capacity at the 20^{th} 0.5C charge/discharge cycle during the cycling test (32^{nd} cycle) to the initial 0.5C discharge capacity at the 1^{st} 0.5C charge/discharge cycle (the 13^{th} cycle) at 75° C.

In some embodiments, the cycling test can be performed at various C rates such as C/6, C/4, C/2, C, 1C, 2C, 3C, 4C, 5C, or any intermediate rate therebetween. In some embodiments, the cycling test can be performed at temperatures such as −20° C., −15° C., −10° C., −5° C., 0° C., 5° C., 10° C., 15° C., 20° C., 25° C., 30° C., 35° C., 40° C., 45° C., 50° C., 55° C., 70° C., 65° C., 75° C., 80° C., or any intermediate temperature therebetween.

The disclosure will be better understood by reference to the experimental details which follow, but those skilled in the art will readily appreciate that the specific experiments detailed are only illustrative, and are not meant to limit the disclosure as described herein, as numerous variations and modifications of these exemplary embodiments are possible without undue experimentation. All such variations and modifications are within the scope of the teachings of this disclosure. It will be appreciated that the foregoing description and following examples, no matter how detailed they may appear in text, the disclosure may be practiced in many ways, and the disclosure should be construed in accordance with the appended claims and equivalents thereof.

It is to be noted that the transitional term “comprising”, which is synonymous with “including”, “containing” or “characterized by”, is inclusive or open-ended and does not exclude additional, un-recited elements or method steps.

### EXAMPLES

### Preparation of Coated CAM

For coated CAM, stoichiometric amounts (Table 1) of a lithium precursor (such as lithium acetate), phosphorous oxide precursor (such as triethyl phosphate), and/or fluoride precursor (such as trifluoroacetic acid) are dissolved in a dry solvent (such as ethanol), forming a coating solution comprising the LPOF precursors. The coating solution was added to a pre-determined amount of CAM, (NCA88, LiNi_{0.88}Co_{0.09}Al_{0.03}O₂), calculated to give a desired coating thickness using the BET surface area of the CAM and an estimated coating density of 2.25 g/cm³. The mixture was stirred for 30 minutes followed by solvent removal via vacuum while being sonicated, leading to a gel coating on the CAM surface with the precursors. The gel coated CAM was then annealed for 1 hour at 400° C. under an oxygen flow to form the CAM particles coated with lithium oxide, phosphorous oxide, lithium fluoride, lithium phosphorous oxide, or fluorine-doped lithium phosphorous oxide (LPOF). In addition to the composition of the coating, LiF/P₂O₅ ratio and F/(Li+P+O) ratio are also listed in Table 1, wherein LiF/P₂O₅ is the molar ratio of LiF to P₂O₅ and the F/(Li+P+O) ratio is the molar ratio of fluorine (F) to all other elements, i.e., lithium (Li), phosphorous (P) and oxygen (O).

### Preparation of Cathode Layers and Assembly of Cells

Cathode layers comprising 65 wt % CAM (coated or uncoated NCA88), 5 wt % carbon fiber (VGCF), and 30 wt % lithium phosphorus sulfur chloride (LPSCl) (Li₆PS₅Cl) were prepared.

Half-cells comprising a Li metal anode, Li₆PS₅Cl (LPSCl) as SE, and the cathode layer comprising one of CAMs in Table 1 and vapor grown carbon fiber (VGCF) were assembled.

### Tests of Cells

The cathode layers were electrochemically evaluated in torque-cells using Li metal on copper as the anode and LPSCl (Li₆PS₅Cl) as the SE. The cells were cycled at 75° C. from 2.5V to 4.25V at 0.1C charge/discharge for 1^{st} and 2^{nd} cycles, 0.33C charge/discharge for 3^{rd} and 4^{th} cycles, 0.5C charge/discharge for 5^{th} and 6^{th} cycles, 1C charge/discharge for 7^{th} and 8^{th} cycles, 2C charge/discharge for 9^{th} and 10^{th} cycles, 5C charge/discharge for 11^{th} and 12^{th} cycles, and 0.5C charge/discharge for 13^{th} to 32^{nd} cycles.

The first 12 cycles were a rate performance test while the 20 cycles starting from the 13^{th} cycle and ending at the 32^{nd} cycle were a cycling test. During the rate test, the discharge capacity retention (Dchg. Cap. Rtn) was calculated by the discharge capacity divided by the initial discharge (Dchg.) capacity (Cap.) at 0.1C multiplied by 100%. The first 20 cycles stability (%) is calculated from the 20^{th} discharge capacity retention at 0.5C during the cycling test divided by the 1^{st} discharge capacity retention at 0.5C during the cycling test, multiplied by 100%.

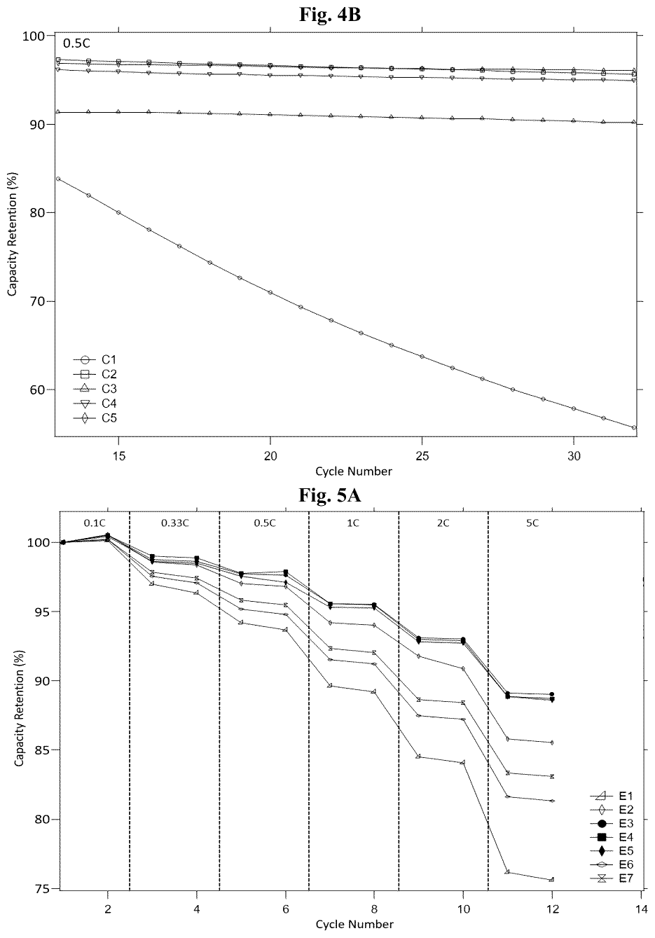

FIG. 4A shows the discharge capacity retention (%) of cells with a cathode of comparative examples (C1 through C5) during the rate test from the 1^{st} cycle to the 12^{th} cycle.

FIG. 4B shows the discharge capacity retention (%) of cells with a cathode of comparative examples (C1 through C5) during the cycling test from the 13^{th} cycle to the 32^{nd} cycle. Each CAM coating has a thickness of around 3 nm except C1 which is uncoated CAM.

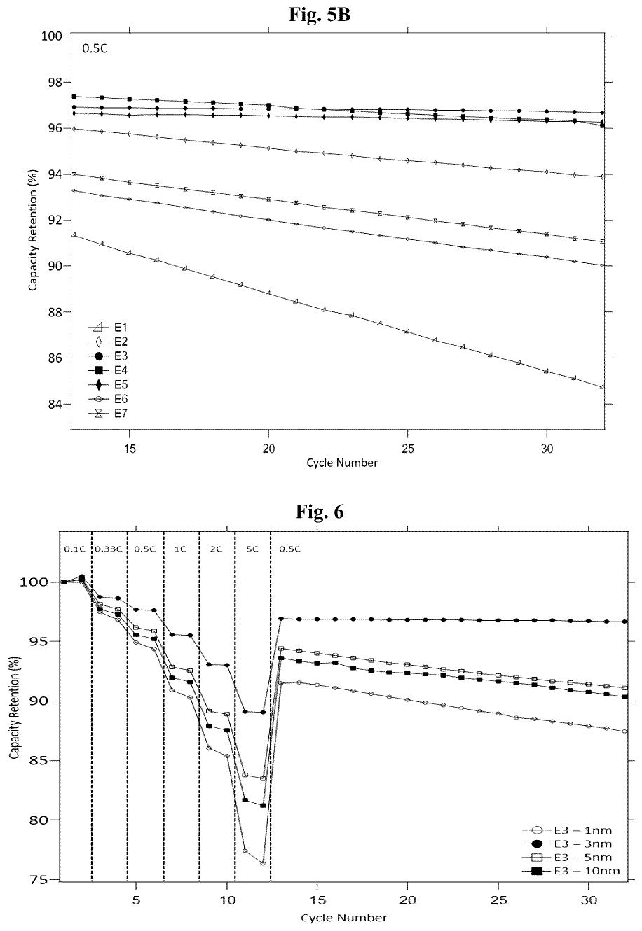

FIG. 5A shows the discharge capacity retention (%) of cells with a cathode of examples (E1 through E7) during the rate test from the 1^{st} cycle to the 12^{th} cycle.

FIG. 5B shows the discharge capacity retention (%) of cells with a cathode of examples from the 1^{st} cycle to the 32^{nd} cycle. Each CAM coating has a thickness of around 3 nm.

TABLE 1
CAM coatings according to some embodiments of the present disclosure

| | Coating Composition (mol %) | | | LiF/P₂O₅ | F/(Li + P + O) |
|---|---|---|---|---|---|
| Example No. | Li₂O | P₂O₅ | LiF | ratio | ratio |
| Comparative example 1 (not | None | None | None | N/A | N/A |
| coated) (C1) | | | | | |
| Comparative example 2 (C2) | 100 | 0 | 0 | N/A | 0 |
| Comparative example 3 (C3) | 0 | 0 | 100 | N/A | 1.00 |
| Comparative example 4 (C4) | 0 | 100 | 0 | N/A | 0 |
| Comparative example 5 (C5) | 75 | 25 | 0 | N/A | 0 |
| Example 1 (E1) | 30 | 50 | 20 | 0.40 | 0.0435 |
| Example 2 (E2) | 40 | 20 | 40 | 2.00 | 0.1333 |
| Example 3 (E3) | 45 | 45 | 10 | 0.22 | 0.0217 |
| Example 4 (E4) | 50 | 30 | 20 | 0.67 | 0.0526 |
| Example 5 (E5) | 55 | 40 | 5 | 0.13 | 0.0111 |
| Example 6 (E6) | 60 | 30 | 10 | 0.33 | 0.0250 |
| Example 7 (E7) | 70 | 20 | 10 | 0.50 | 0.0278 |

TABLE 2-1
Initial discharge capacity and rate performance of cells

| CAM | | Dchg. Cap. Rtn (%) | | | | |
|---|---|---|---|---|---|---|
| Example | Initial Dchg Cap | @ | @ | @ | @ | @ |
| No. | (mAh/g) @0.1 C | 1^{st} 0.33 C | 1^{st} 0.5 C | 1^{st} 1 C | 1^{st} 2 C | 1^{st} 5 C |
| C1 | 210.98 | 99.89 | 96.20 | 89.08 | 79.72 | 62.82 |
| C2 | 204.88 | 99.12 | 97.93 | 96.01 | 93.55 | 89.65 |
| C3 | 209.53 | 95.78 | 93.53 | 88.82 | 81.82 | 69.16 |
| C4 | 214.63 | 98.32 | 97.11 | 94.48 | 91.29 | 86.12 |
| C5 | 216.64 | 98.43 | 97.40 | 95.10 | 92.43 | 88.37 |
| E1 | 206.89 | 96.99 | 94.20 | 89.61 | 84.51 | 76.15 |
| E2 | 201.44 | 98.58 | 97.03 | 94.19 | 91.76 | 85.80 |
| E3 | 228.37 | 98.72 | 97.69 | 95.57 | 93.09 | 89.11 |
| E4 | 215.28 | 98.97 | 97.74 | 95.55 | 92.97 | 88.85 |
| E5 | 217.65 | 98.61 | 97.53 | 95.31 | 92.79 | 88.84 |
| E6 | 217.79 | 97.54 | 95.15 | 91.50 | 87.47 | 81.62 |
| E7 | 207.52 | 97.83 | 95.80 | 92.32 | 88.65 | 83.34 |

As shown in Table 2-1, the cells comprising a cathode with C1 through C5 exhibited an initial discharge specific capacity of 210.98 mAh/g, 204.88 mAh/g, 209.53 mAh/g, 214.63 mAh/g and 216.64 mAh/g at 0.1C, respectively. The cells comprising a cathode of E1 and E7 exhibited an initial discharge specific capacity of 206.89 mAh/g, 201.44 mAh/g, 228.37 mAh/g, 215.28 mAh/g, 217.65 mAh/g, 217.79 mAh/g and 207.52 mAh/g at 0.1C, respectively. None of the comparative examples could simultaneously achieve a good initial specific discharge capacity at 0.1C and a good rate performance. Examples E3 through E5 exhibited a good initial specific discharge capacity at 0.1C of at least 215.0 mAh/g and a rate performance.

In some embodiments, it is challenging to achieve both a high initial discharge capacity and a high retention rate at a high C rate. None of comparative examples could achieve both an initial specific discharge capacity at 0.1C of at least 215.0 mAh/g and a discharge capacity retention rate at 2C of at least 92.50%. In contrast, E3, E4, E5 exhibited an initial discharge specific capacity of at least 215.0 mAh/g at 0.1C and a discharge capacity retention rate at 2C of 93.09%, 92.97%, and 92.79%, respectively. It suggests a better rate performance.

On the other hand, none of comparative examples could achieve both an initial specific discharge capacity at 0.1C of at least 215.0 mAh/g and a discharge capacity retention rate at 5C of at least 88.50%. In contrast, E3, E4 and E5 exhibited an initial discharge specific capacity of at least 215.0 mAh/g at 0.1C and a discharge capacity retention rate at 5C of 89.11%, 88.85%, and 88.84%, respectively.

TABLE 2-2
Cycling performance of cells

| CAM | Dchg. Cap. Rtn | Dchg. Cap. Rtn | |
|---|---|---|---|
| Example | (%) @ 1^{st} | (%) @ 20^{th} | First 20 cycles |
| No. | 0.5 C | 0.5 C | stability (%) |
| C1 | 83.83 | 54.80 | 70.14 |
| C2 | 97.29 | 95.63 | 98.29 |
| C3 | 90.94 | 90.16 | 99.14 |
| C4 | 96.10 | 94.92 | 98.77 |
| C5 | 96.85 | 96.03 | 99.15 |
| E1 | 91.34 | 84.74 | 92.77 |
| E2 | 95.97 | 93.87 | 97.81 |
| E3 | 96.90 | 96.67 | 99.76 |
| E4 | 97.37 | 96.11 | 98.71 |
| E5 | 96.64 | 96.25 | 99.60 |
| E6 | 93.28 | 89.45 | 95.89 |
| E7 | 94.00 | 91.08 | 96.89 |

Table 2-2 shows the cycling performance of the cells comprising a cathode with different CAM coatings, i.e., from the 13^{th} cycle to the 32^{nd} cycle at 0.5C. None of the comparative examples could achieve a first 20 cycles stability of 99.20% or higher. In contrast, examples 3 and 5 (E3 and E5) unexpectedly achieved a first 20 cycles stability of 99.76% and 99.60%, respectively. It suggests a better cycling performance.

In some embodiments, it may be challenging to achieve a high initial specific discharge capacity, a good rate performance and a good cycling performance. In some embodiments, examples 3 and 5 exhibited an initial specific discharge capacity of at least 215.0 mAh/g at 0.1C, a discharge capacity retention of at least 92.50% at 2C, a discharge capacity retention of at least 88.50% at 5C, and a first 20 cycles stability of at least 99.20% at 0.5C. In some embodiments, the molar ratio of LiF to P₂O₅ is no greater than 0.30 or no greater than 0.25.

TABLE 3-1
Rate performance of cells comprising E3 cathode
with different coating thicknesses

| | Initial Dchg | Dchg. Cap. Rtn (%) | | | | |
|---|---|---|---|---|---|---|
| CAM coating | Cap (mAh/g) | @ | @ | @ | @ | @ |
| thickness, nm | @0.1 C | 1^{st} 0.33 C | 1^{st} 0.5 C | 1^{st} 1 C | 1^{st} 2 C | 1^{st} 5 C |
| 1.0 | 214.94 | 97.47 | 94.94 | 90.90 | 86.05 | 77.39 |
| 3.0 | 228.37 | 98.72 | 97.69 | 95.57 | 93.09 | 89.11 |
| 5.0 | 206.01 | 98.11 | 96.17 | 92.88 | 89.15 | 83.77 |
| 10.0 | 212.29 | 97.73 | 95.57 | 91.96 | 87.89 | 81.69 |

FIG. 6 illustrates the discharge capacity retentions of cells with a cathode of example 3 with different thicknesses during the rate test and cycling test. The initial specific discharge capacity and rate performance are summarized in Table 3-1. The cycling performance of the cells is summarized in Table 3-2.

TABLE 3-2
Cycling performance of cells comprising E3
cathode with different coating thicknesses

| CAM | | | First 20 |
|---|---|---|---|
| coating | Dchg. Cap. Rtn (%) | Dchg. Cap. Rtn | cycles |
| thickness | 1^{st} @ 0.5 C | 20^{th} @ 0.5 C | stability (%) |
| 1.0 | 91.50 | 87.43 | 95.55 |
| 3.0 | 96.90 | 96.67 | 99.76 |
| 5.0 | 94.43 | 91.13 | 96.51 |
| 10.0 | 93.60 | 90.35 | 96.52 |

As shown in Tables 3-1 and 3-2, the thickness of the CAM coating plays an important role in view of the rate performance and cycling performance. When the CAM coating of example 3 is too thin, for example 1 nm, the cells exhibited a poor rate performance and a relatively low first 20 cycles stability. It is probably due to poor and/or ineffective coverage that cannot effectively reduce the degradation. On the other hand, when the CAM coating is too thick, for example, 5.0 nm and 10.0 nm, the rate performance and the cycling stability become less desirable. Unexpectedly, the CAM coating with a thickness of around 3 nm achieved a high initial specific discharge capacity, a high rate performance and a good cycling performance.

TABLE 4-1
Rate performance of cells comprising E4 cathode
with different coating thicknesses

| CAM | | Dchg. Cap. Rtn (%) | | | | |
|---|---|---|---|---|---|---|
| coating | Initial Dchg Cap | @ | @ | @ | @ | @ |
| thickness | @0.1 C (mAh/g) | 1^{st} 0.33 C | 1^{st} 0.5 C | 1^{st} 1 C | 1^{st} 2 C | 1^{st} 5 C |
| 1.0 | 212.87 | 98.14 | 96.39 | 93.49 | 90.11 | 84.92 |
| 3.0 | 215.28 | 98.97 | 97.74 | 95.55 | 92.97 | 88.85 |
| 5.0 | 219.38 | 98.57 | 96.90 | 94.00 | 90.71 | 85.70 |
| 10.0 | 206.19 | 98.25 | 96.48 | 93.34 | 90.18 | 85.01 |

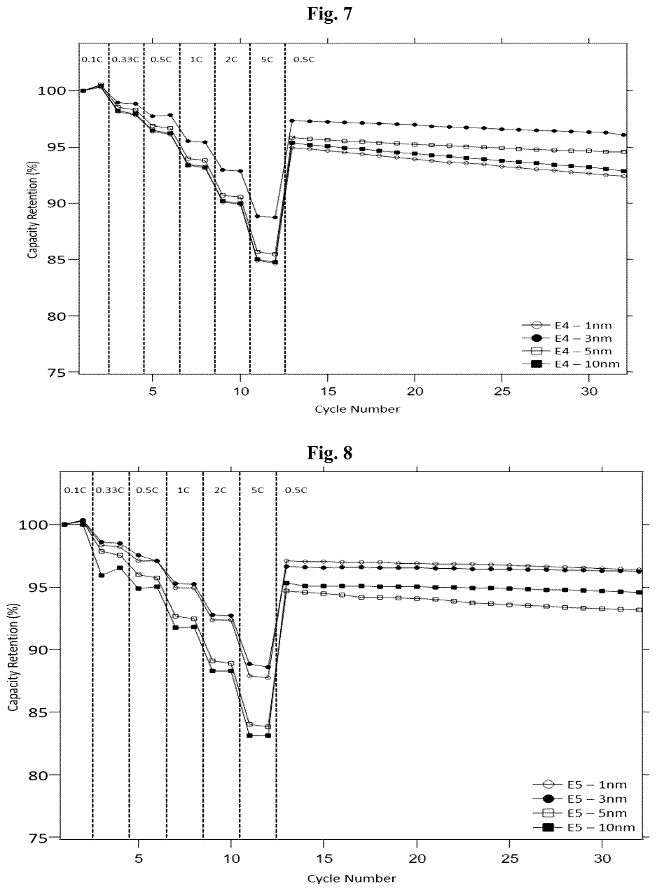

FIG. 7 illustrates the discharge capacity retentions of cells with a cathode of example 4 with different thicknesses during the rate test and cycling test. The initial specific discharge capacity and rate performance are summarized in Table 4-1. The cycling performance of the cells is summarized in Table 4-2.

TABLE 4-2
Cycling performance of cells comprising E4
cathode with different coating thicknesses

| | Dchg. Cap. Rtn | Dchg. Cap. Rtn | |
|---|---|---|---|
| CAM coating | (%) @ 1^{st} | (%) @ 20^{th} | First 20 cycles |
| thickness | 0.5 C | 0.5 C | stability (%) |
| 1.0 | 94.95 | 92.43 | 97.35 |
| 3.0 | 97.37 | 96.11 | 98.71 |
| 5.0 | 95.83 | 94.60 | 98.72 |
| 10.0 | 95.39 | 92.87 | 97.36 |

Tables 4-1 and 4-2 show the influence of coating thickness of example 4 (E4) on rate and cycling performance. When the CAM coating of example 4 is too thin, the cell exhibited a poor rate performance and a relatively low first 20 cycles stability. When the CAM coating has a thickness around 3 nm, the cell exhibited both good rate performance and cycling performance. When the CAM coating is too thick, for example 5 nm, the cell exhibited a good rate performance but relatively poor cycling performance. When the CAM coating has a relatively high thickness, e.g., 10.0 nm, the rate performance and the cycling stability became less desirable.

FIG. 8 illustrates the discharge capacity retentions of cells with a cathode of example 5 (E5) with different thicknesses during the rate test and cycling test. The initial specific discharge capacity and rate performance are summarized in Table 5-1. The cycling performance of the cells is summarized in Table 5-2.

TABLE 5-1
Rate performance of cells comprising E5 cathode
with different coating thicknesses

| CAM | | Dchg. Cap. Rtn (%) | | | | |
|---|---|---|---|---|---|---|
| coating | Initial Dchg Cap | @ | @ | @ | @ | @ |
| thickness | (mAh/g) @0.1 C | 1^{st} 0.33 C | 1^{st} 0.5 C | 1^{st} 1 C | 1^{st} 2 C | 1^{st} 5 C |
| 1.0 | 226.29 | 98.37 | 97.12 | 94.95 | 92.39 | 87.88 |
| 3.0 | 217.65 | 98.61 | 97.53 | 95.31 | 92.79 | 88.84 |
| 5.0 | 215.40 | 97.88 | 96.00 | 92.66 | 89.10 | 83.99 |
| 10.0 | 198.19 | 95.97 | 94.87 | 91.76 | 88.31 | 83.13 |

TABLE 5-2
Cycling performance of cells comprising E5
cathode with different coating thicknesses

| | Dchg. Cap. Rtn | Dchg. Cap. Rtn | |
|---|---|---|---|
| CAM coating | (%) @ 1^{st} | (%) @ 20^{th} | First 20 cycles |
| thickness | 0.5 C | 0.5 C | stability (%) |
| 1.0 | 97.09 | 96.42 | 99.31 |
| E5_3.0 | 96.64 | 96.25 | 99.60 |
| 5.0 | 94.58 | 93.18 | 98.52 |
| 10.0 | 95.32 | 94.61 | 99.25 |

Tables 5-1 and 5-2 show the influence of coating thickness of example 5 on cells' rate and cycling performance. When the CAM coating of E5 has a thickness of 10 nm, the initial specific discharge capacity dropped significantly to around 198 mAh/g which is significantly lower than that of other three thicknesses. In addition, the cell exhibited a poor rate performance, for example, a discharge capacity retention of 83.13% at 5C, but a good cycling stability with a first 20 cycles stability of 99.25%. When the CAM coating has a thickness of 5 nm, the cell exhibited a slightly better but still poor rate performance, e.g., a discharge capacity retention of 83.99% at 5C, and a poor cycling performance with a first 20 cycles stability of 98.52%. Only when the coating thickness is 3 nm or less, the cell exhibited a high initial discharge capacity, a good rate performance and a cycling performance with a first 20 cycles stability of at least 99.30%.

### Aspects

In a first aspect, the present disclosure provides a coated cathode active material comprising particle of a cathode active material (CAM) and a coating at least partially coated on the particle, wherein the coating is a F-doped lithium phosphorus oxide, wherein the F-doped lithium phosphorus oxide has a formula of (Li₂O)ₓ—(P₂O₅)_{y}—(AFₘ)_{z}, wherein x+y+z=1.0, 0.3<x<0.8, 0.2<y<0.7, and 0<z≤0.2, wherein A is an alkali metal or alkaline earth metal, wherein m is 1 or 2.

In a second aspect according to the first aspect, 0<z≤0.15. In some embodiments, 0<z≤0.10.

In a third aspect according to the first or second aspect, 0.40≤x≤0.60. In some embodiments, 0.30≤y≤0.50.

In a fourth aspect according to the first aspect, the formula has a molar ratio of AFₘ to P₂O₅ having a value greater than zero and no greater than 0.30. In some embodiments, A is at least one selected from the group consisting of Li, Na, K, Rb, Be, Mg, Ca, and Sr.

In a fifth aspect according to any preceding aspect, the formula has a molar ratio of fluorine (F) to phosphorus (P) having a value greater than zero and no greater than 0.15.

In a sixth aspect according to any preceding aspect, the formula has a F/(Li+P+O) ratio greater than zero and no greater than 0.025, wherein the F/(Li+P+O) ratio is a molar ratio of fluorine (F) to lithium (Li), phosphorous (P) and oxygen (O). In some embodiments, the F/(Li+P+O) ratio is greater than zero and no greater than 0.022.

In a seventh aspect according to any preceding aspect, the coating has a thickness of no greater than 3.0 nm. In some embodiments, the particle is either polycrystalline or single crystalline and has a median particle size of 1-15 μm.

In an eighth aspect according to any preceding aspect, the coating is substantially free of polymer. As used herein, the term “substantially free of” an ingredient(s) as provided throughout the disclosure is intended to mean that the composition or device contains less than about 0.5 wt % (percent by weight of the total weight of the composition or device), or insignificant or negligible amounts of said ingredient(s) unless specifically indicated otherwise.

In a nineth aspect according to any preceding aspect, the CAM is selected from the group consisting of LiₓMn_{1-y}M_{y}A₂, LiₓMn_{1-y}M_{y}O_{2-z}X_{z}, LiₓMn₂O_{4-z}X_{z}, LiₓMn_{2-y}M_{y}A₄, LiₓCo_{1-y}M_{y}A₂, LiₓCo_{1-y}M_{y}O_{2-z}X_{z}, LiₓNi_{1-y}M_{y}A₂, LiₓNi_{1-y}M_{y}O_{2-z}X_{z}, LiₓNi_{1-y}Co_{y}O_{2-z}X_{z}, LiₓNi_{1-y-z}Co_{y}M_{z}Aₐ, LiₓNi_{1-y-z}Co_{y}M_{z}O₂₋ₐXₐ, LiₓNi_{1-y-z}Mn_{y}M_{z}Aₐ, LiₓNi_{1-y-z}Mn_{y}M_{z}O₂₋ₐXₐ, and mixtures thereof, wherein 0.95≤x≤1.1, 0≤y≤0.5, 0≤z≤0.5, 0≤a≤2; M is selected from the group consisting of Al, Ni, Co, Mn, Cr, Fe, Mg, Sr, V, and rare earth elements; A is selected from the group consisting of O, F, S, and P; and X is selected from the group consisting of F, S, and P.

In a tenth aspect according to any preceding aspect, the F-doped lithium phosphorus oxide has a formulation selected from the group consisting of (Li₂O)_{0.45}—(P₂O₅)_{0.45}—(LiF)_{0.10}, (Li₂O)_{0.55}—(P₂O₅)_{0.40}—(LiF)_{0.05}, and mixtures thereof. In some embodiments, the F-doped lithium phosphorus oxide has a formulation selected from the group consisting of (Li₂O)_{0.45}—(P₂O₅)_{0.45}—(LiF)_{z}, (Li₂O)_{0.55}—(P₂O₅)_{0.40}—(LiF)_{z}, and mixtures thereof, wherein 0<z≤0.10.

In an eleventh aspect, the present disclosure provides a method for preparing coated cathode active material as disclosed herein. The method comprises:
a) preparing a coating solution comprising a predetermined amount of a lithium precursor, phosphorous precursor and fluoride precursor in a solvent,
b) mixing the coating solution with an uncoated cathode active material into a mixture,
c) removing the solvent from the mixture, leading to a gel, wherein a coating of gel is formed on the CAM, leading to a CAM coated with the gel, and
d) annealing the CAM coated with the gel in an oxygen atmosphere, wherein the lithium, phosphorous, and fluoride precursors are converted into a F-doped lithium phosphorus oxide, thereby obtaining a coated cathode active material.

In a twelfth aspect according to the eleventh aspect, the solvent for preparing the coating solution is non-aqueous and is selected from the group consisting of methanol, ethanol, isopropanol, n-propanol, t-butanol, tetrahydrofuran, and mixtures thereof. In some embodiments, the CAM coated with the gel is annealed in a range from 150 to 500° C. for a duration in a range from 0.5 to 3 hours under an oxygen atmosphere.

In a thirteenth aspect, the present disclosure provides a cathode layer comprising the coated cathode active material according to any of the first through tenth aspects. In some embodiments, the coated cathode active material has a percentage of at least 65 wt % in the cathode layer. In some embodiments, the cathode layer further comprises an electrically conductive material and a sulfur-containing inorganic electrolyte. In some embodiments, the electrically conductive material is selected from carbon fiber, vapor growth carbon fiber, carbon nanotube, graphite fiber, and mixtures thereof. In some embodiments, the sulfur-containing inorganic electrolyte has a formula of LiₓM1_{y}M2_{z}P₁₋ₚM3ₚS_{6-a-b-q}O_{q}ClₐBr_{b} (Formula II), wherein 4≤x≤8, 0≤y<1, 0≤z<1, 0≤p<1, 0≤q<1, 0≤a≤2, 0≤b<2, 0<6-a-b-q<6, 0<1-p<1, wherein M1 is at least one element of Group 1 or Group 11 other than H or Li of the periodic table, M2 is at least one element of Group 2 of the periodic table, and M3 is at least one element of Group 14 of the periodic table.

In a fourteenth aspect, the present disclosure provides an all-solid-state battery (ASSB) comprising the cathode layer according to the thirteenth aspect and an inorganic solid electrolyte layer, wherein the inorganic solid electrolyte layer comprises a sulfur-containing inorganic electrolyte. In some embodiments, the sulfur-containing inorganic electrolyte has a formula LiₓM1_{y}M2_{z}P₁₋ₚM3ₚS_{6-a-b-q}O_{q}ClₐBr_{b} (Formula II), wherein 4≤x≤8, 0≤y<1, 0≤z<1, 0≤p<1, 0≤q<1, 0≤a<2, 0≤b<2, 0<6-a-b-q<6, 0<1-p<1, wherein M1 is at least one element of Group 1 or Group 11 other than H or Li of the periodic table, M2 is at least one element of Group 2 of the periodic table, and M3 is at least one element of Group 14 of the periodic table.

In a fifteenth aspect according to the fourteenth aspect, the ASSB possesses at least one characteristic of the following:
a) an initial discharge specific capacity of at least 215.0 mAh/g at 0.1C;
b) a discharge capacity retention of at least 92.50% at 2C;
c) a discharge capacity retention of at least 88.50% at 5C; and
d) a first 20 cycles stability of at least 99.20% at 0.5C,
wherein the discharge capacity retention at 2C is the 1^{st} discharge capacity at 2C divided by the initial discharge capacity at 0.1C multiplied by 100%, the discharge capacity retention at 5C is the 1^{st} discharge capacity at 5C divided by the initial discharge capacity at 0.1C multiplied by 100%, and the first 20 cycles stability is the 20^{th} cycle-life capacity retention at 0.5C divided by the 1^{st} cycle-life capacity retention at 0.5C multiplied by 100%.

All transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Various embodiments of the features of this disclosure are described herein. However, it should be understood that such embodiments are provided merely by way of example, and numerous variations, changes, and substitutions can occur to those skilled in the art without departing from the scope of this disclosure. It should also be understood that various alternative to the specific embodiments described herein are also within the scope of this disclosure.

1. A coated cathode active material comprising particle of a cathode active material (CAM) and a coating at least partially coated on the particle, wherein the coating is a F-doped lithium phosphorus oxide, wherein the F-doped lithium phosphorus oxide has a formula of (Li₂O)ₓ(P₂O₅)_{y}—(AFₘ)_{z}, wherein x+y+z=1.0, 0.3<x<0.8, 0.2<y<0.7, and 0<z≤0.2, wherein A is an alkali metal or alkaline earth metal, wherein m is 1 or 2.

2. The coated cathode active material of claim 1, wherein 0<z≤0.15.

3. The coated cathode active material of claim 1, wherein 0.40≤x≤0.60.

4. The coated cathode active material of claim 1, wherein the formula has a molar ratio of AFₘ to P₂O₅ having a value of no greater than 0.30.

5. The coated cathode active material of claim 1, wherein the formula has a molar ratio of fluorine (F) to phosphorus (P) having a value of no greater than 0.15.

6. The coated cathode active material of claim 1, wherein the formula has a F/(Li+P+O) ratio greater than zero and no greater than 0.025, wherein the F/(Li+P+O) ratio is a molar ratio of fluorine (F) to lithium (Li), phosphorous (P) and oxygen (O).

7. The coated cathode active material of claim 1, wherein the coating has a thickness of 3 nm or less.

8. The coated cathode active material of claim 1, wherein the coating is substantially free of polymer.

9. The coated cathode active material of claim 1, wherein the CAM is selected from the group consisting of LiₓMn_{1-y}M_{y}A₂, LiₓMn_{1-y}M_{y}O_{2-z}X_{z}, LiₓMn₂O₄-X_{z}, LiₓMn_{2-y}M_{y}A₄, LiₓCo_{1-y}M_{y}A₂, LiₓCo_{1-y}M_{y}O_{2-z}X_{z}, LiₓNi_{1-y}M_{y}A₂, LiₓNi_{1-y}M_{y}O_{2-z}X_{z}, LiₓNi_{1-y}Co_{y}O_{2- z}X_{z}, LiₓNi_{1-y-z}Co_{y}M_{z}Aₐ, LiₓNi_{1-y-z}Co_{y}M_{z}O₂₋ₐXₐ, LiₓNi_{1-y-z}Mn_{y}M_{z}Aₐ, LiₓNi_{1-y-z}Mn_{y}M_{z}O₂₋ₐXₐ, and mixtures thereof, wherein 0.95≤x≤1.1, 0≤y≤0.5, 0≤z≤0.5, 0≤a≤2; M is selected from the group consisting of Al, Ni, Co, Mn, Cr, Fe, Mg, Sr, V, and rare earth elements; A is selected from the group consisting of O, F, S, and P; and X is selected from the group consisting of F, S, and P.

10. The coated cathode active material of claim 1, wherein the F-doped lithium phosphorus oxide has a formulation selected from the group consisting of (Li₂O)_{0.45}—(P₂O₅)_{0.45}—(LiF)_{0.10}, (Li₂O)_{0.55}—(P₂O₅)_{0.40}—(LiF)_{0.05}, and mixtures thereof.

11. A method for preparing coated cathode active material of claim 1, comprising:
a) preparing a coating solution comprising a predetermined amount of a lithium precursor, phosphorous precursor and fluoride precursor in a solvent,
b) mixing the coating solution with an uncoated cathode active material into a mixture,
c) removing the solvent from the mixture, leading to a gel, wherein a coating of gel is formed on the CAM, leading to a CAM coated with the gel, and
d) annealing the CAM coated with the gel in an oxygen atmosphere, wherein the lithium, phosphorous, and fluoride precursors are converted into a F-doped lithium phosphorus oxide, thereby obtaining a coated cathode active material.

12. The method of claim 11, wherein the solvent for preparing the coating solution is non-aqueous and is selected from the group consisting of methanol, ethanol, isopropanol, n-propanol, t-butanol, tetrahydrofuran, and mixtures thereof and the CAM coated with the gel is annealed in a range from 150 to 500° C. for a duration in a range from 0.5 to 3 hours under an oxygen atmosphere.

13. A cathode layer comprising the coated cathode active material of claim 1.

14. An all-solid-state battery (ASSB) comprising the cathode layer of claim 13 and an inorganic solid electrolyte layer, wherein the inorganic solid electrolyte layer comprises a sulfur-containing inorganic electrolyte.

15. The ASSB of claim 14, where the ASSB possesses at least one characteristic of the following:
a) an initial discharge specific capacity of at least 215.0 mAh/g at 0.1C;
b) a discharge capacity retention of at least 92.50% at 2C;
c) a discharge capacity retention of at least 88.50% at 5C; and
d) a first 20 cycles stability of at least 99.20% at 0.5C,
wherein the discharge capacity retention at 2C is the 1^{st} discharge capacity at 2C divided by the initial discharge capacity at 0.1C multiplied by 100%, the discharge capacity retention at 5C is the 1^{st} discharge capacity at 5C divided by the initial discharge capacity at 0.1C multiplied by 100%, and the first 20 cycles stability is the 20^{th} cycle-life capacity retention at 0.5C divided by the 1^{st} cycle-life capacity retention at 0.5C multiplied by 100%.
